(19) United States
(12) Patent Application Publication
(10) Pub. No.: US 2002/0137388 A1
(43) Pub. Date: Sep. 26, 2002

(54) Power adapter and the power cord take-up device thereof

(76) Inventor: Chia-Fu Liu, Taoyuan Shien (TW)

Correspondence Address: Niro, Scavone, Haller & Niro, Suite 4600, 191 West Madison Street, Chicago, IL, 60602, US

(21) Appl. No.: 10/012,955

(22) Filed: Dec. 10, 2001

(30) Foreign Application Priority Data
Mar. 20, 2001 (TW) 90204175

(51) Int. Cl. H01R 13/72

(52) U.S. Cl. 439/501

(57) ABSTRACT

A power adapter and a power cord take-up device thereof comprises a housing, a power cord with one end thereof connected to the housing, a take-up reel having a centered projecting member, wherein a top of the centered projecting member is connected with the housing, so as to wind the power cord around the take-up reel to gather the power cord up by the centered projecting member.

### FIELD OF THE INVENTION

The present invention is related to a power cord take-up device, and more particularly to a power adapter and the power cord take-up device thereof for receiving a power cord.

### BACKGROUND OF THE INVENTION

An electronic appliance, such as a printer, a radio, a modem (modulator-demodulator) and so forth will be equipped with a power adapter for rectifying and converting the commercially available power into direct current (DC) power, so as to supply the required power to operate these electronic appliances.

A prior art power adapter structure is shown in FIG. 1. As depicted in FIG. 1, the prior art power adapter principally comprises a housing 11, wherein one side 111 of the housing 11 acts as a power receiving terminal. A connector 13 is submerged in the slot 12 on the side 111 for matching with a corresponding connector 161. The connector 161 is provided on one end of a power cable 162, while the other end of the power cable 162 is provided with a plug 163. The power adapter of FIG. 1 receives commercially available power by connecting the plug 163 to a wall outlet (not shown). When a consumer purchases a power adapter, generally a bundling strap 15 will be enclosed in the encasement of the power adapter for the purpose of bundling the power cord 14 when the power adapter is no longer used. When one desires to use the power adapter, the bundling strap 15 has to be unfastened in advance and the power cord 14 can be stretched out to connect with a power receiving device (not shown).

However, the foregoing power cord take-up mechanism for a power adapter causes some cumbersome problems in practical operation:

1. Because the bundling strap 15 is isolated from the power adapter housing 11, the bundling strap 15 is likely to lose, and

2. After the bundling strap 15 has been bundled with the power cord 14, the power cord 14 will be hanged over the housing 11, such that the power cord 14 is not easy to be gathered up in order and thus occupies a lot of space.

There is a need to provide a power adapter and a power core take-up device thereof which can gather the power cord up in order and save more space.

### SUMMARY OF THE INVENTION

An object of the present invention is to provide a power core take-up device which is designed for solving the problems encountered by the prior art, and it is characterized by enabling the power cord to be received around the take-up reel provided on the power adapter, in such a way that the power cord can be gathered up in order.

A first aspect of the present invention is associated with a power cord take-up device, comprising a housing, a power cord with one end thereof connected with the housing, and a take-up reel having a centered projecting member, wherein a top of the centered projecting member is connected with the housing, so as to wind the power cord around the take-up reel to gather the power cord up by the centered projecting member.

In accordance with the power cord take-up device as described hereinbefore, the housing is indicative of a power adapter housing.

In accordance with the power cord take-up device as described hereinbefore, the housing is further divided into an upper housing and a lower housing.

In accordance with the power cord take-up device as described hereinbefore, wherein an alternating current (AC) power plug is further provided between the upper housing and the lower housing.

In accordance with the power cord take-up device as described hereinbefore, the take-up reel is further provided with a projecting flange.

A second aspect of the present invention is in connection with a power adapter comprising an upper housing, a lower housing for being coupled with the upper housing, an alternating current (AC) power plug being submerged between the upper housing and the lower housing, a power cord with one end thereof connected with the lower housing, and a take-up reel having a centered projecting member, wherein a top of the projecting member is connected with either the upper housing or the lower housing, so as to wind the power cord around the take-up reel to gather the power cord up by the centered projecting member.

The power adapter as described hereinbefore is further provided with a projecting flange on the take-up reel.

Now the foregoing and other features and advantages of the present invention will be more clearly understood through the following descriptions with reference to the accompanying drawings, in which:

### BRIEF DESCRIPTION OF THE DRAWINGS

FIG. 1 is an elevation view showing the power cord take-up device of the prior art;

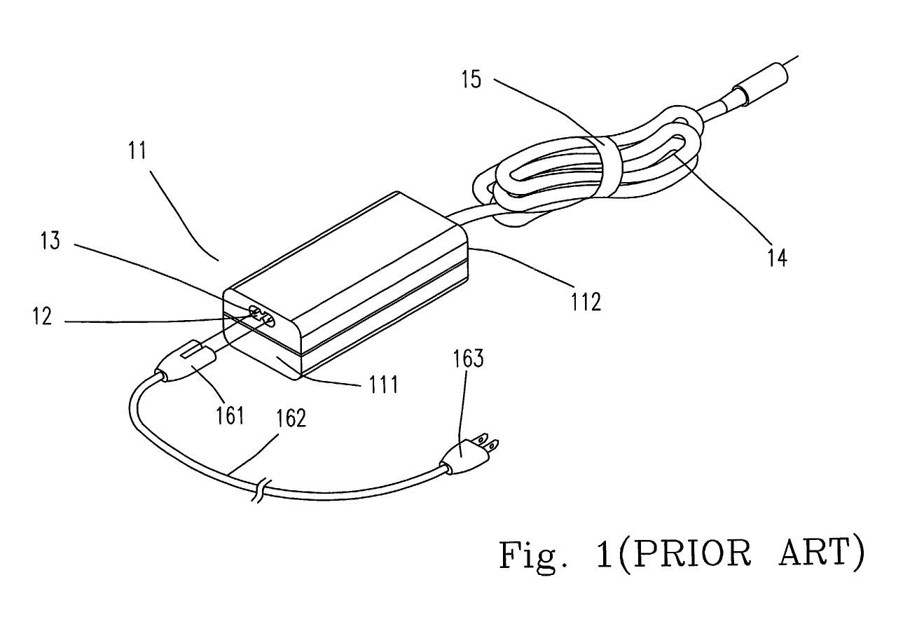

FIG. 2(a) is an exploded view showing the power cord take-up device according to a preferred embodiment of the present invention; and

FIG. 2(b) is an elevation view showing the power cord take-up device according to a preferred embodiment of the present invention.

### DETAILED DESCRIPTION OF THE PREFERRED EMBODIMENT

An exemplary embodiment of the power adapter and the power cord take-up device thereof of the present invention now will be fully described with reference to the following preferred embodiment. It is to be emphasized that the following descriptions of embodiments and examples of the present invention is only illustrative, and it is not intended to be exhaustive or not to be limited to the precise form disclosed.

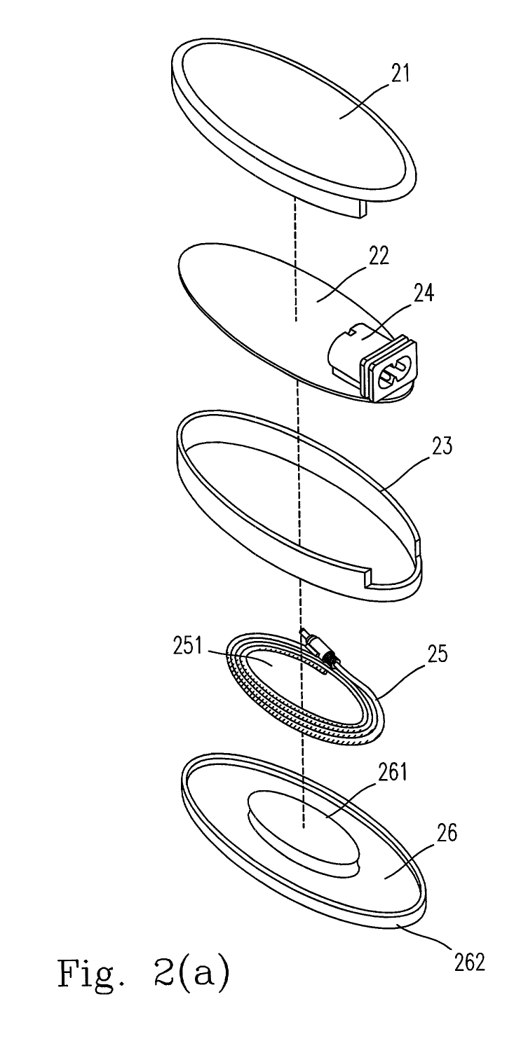

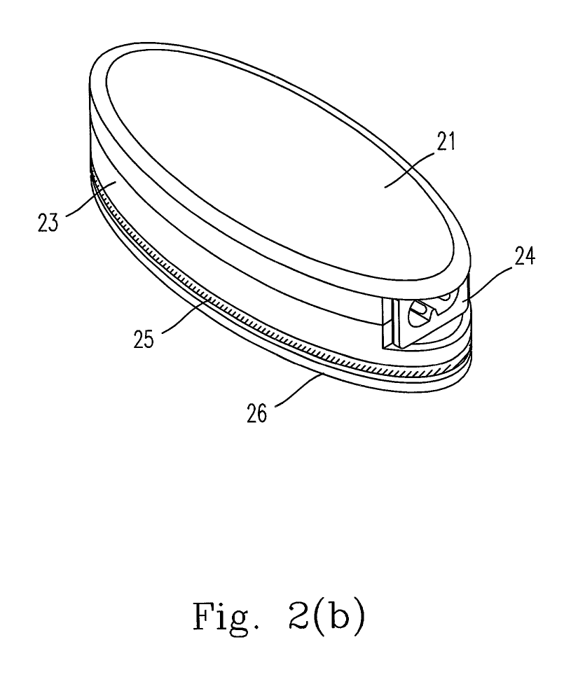

FIG. 2(a) and FIG. 2(b) respectively depicts an exploded view and an elevation view of the power adapter with power cord take-up device according to a preferred embodiment of the present invention. The power adapter of the present invention includes an upper housing 21, a circuit board 22, a lower housing 23, an alternating current (AC) power plug 24, a power cord 25 and a take-up reel 26. The AC power plug 24 is submerged between the upper housing 21 and the lower housing 23. One end 251 of the power cord 25 is connected to the lower housing 23. The take-up reel 26 has a centered projecting member 261 which has a top to be connected with the lower housing 23 (certainly, the take-up reel 26 and the projecting member 261 can be connected with upper housing 21). The takeup reel 26 further provides a projecting flange 262 for enabling the entwined power cord 25 to be fixed in position onto the take-up reel 26.

To conclude, the present invention is characterized by that the power cord take-up device comprising the take-up reel 26 and the projecting member 261 is connected with the power adapter housing, and the power cord 25 is winded around the projecting member 261 of the take-up reel 26. Therefore, the power adapter and the power cord take-up device thereof has a simple structure and can eliminate the inconveniences caused by the bundling strap and the large occupied space. As a result, the power adapter and the power cord take-up device thereof of the present invention is convenient to be garnered up.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claim is:

1. A power cord take-up device comprising:
a housing;
a power cord with one end thereof connected to said housing; and
a take-up reel having a centered projecting member, wherein a top of said centered projecting member is connected with said housing, so as to wind said power cord around said take-up reel to gather said power cord up by said centered projecting member.

2. A power cord take-up device of claim 1 wherein said housing is indicative of a power adapter housing.

3. A power cord take-up device of claim 1 wherein said housing comprises an upper housing and a lower housing.

4. A power cord take-up device of claim 1 wherein an alternating current (AC) power plug is further provided between said upper housing and said lower housing.

5. A power cord take-up device of claim 1 wherein said take-up reel is further provided with a projecting flange.

6. A power adapter comprising:
an upper housing;
a lower housing being coupled with said upper housing;
an alternating current (AC) power plug being submerged between said upper housing and said lower housing;
a power cord with one end thereof connected with said lower housing; and
a take-up reel having a centered projecting member, wherein a top of said centered projecting member is connected with said either said upper housing or said lower casing, so as to wind said power cord around said take-up reel to gather said power cord up by said centered projecting member.

7. A power adapter of claim 6 wherein said take-up reel is further provided with a projecting flange.
